(19) United States
(12) Patent Application Publication
(10) Pub. No.: US 2024/0046154 A1
(43) Pub. Date: Feb. 8, 2024

(54) APPARATUS AND METHOD FOR AUTOMATED REWARD SHAPING

(71) Applicant: HUAWEI TECHNOLOGIES CO., LTD., Shenzhen (CN)

(72) Inventors: David MGUNI, London (GB); Nicolas PEREZ NIEVES, London (GB); Jianhong WANG, London (GB)

(21) Appl. No.: 18/365,818

(22) Filed: Aug. 4, 2023

Related U.S. Application Data
(63) Continuation of application No. PCT/EP2021/052680, filed on Feb. 4, 2021.

(51) Int. Cl. G06N 20/00

(52) U.S. Cl. CPC G06N 20/00

(57) ABSTRACT

A machine learning apparatus is configured to form an output value function for achieving an objective by iteratively performing: implementing a current state of the first agent function based on a current environmental state to form a subsequent environmental state and a first reward; a determining with the second agent function whether to use a second reward; if that determination has a negative outcome, refining the first agent function based on the first reward; and otherwise computing the second reward according to a predetermined reward function and refining the first agent function based on the first reward and the second reward; refining the second agent function based on a performance of the first agent function in meeting the objective; and adopting the subsequent environmental state as the current environmental state; and subsequently outputting the current state of the first agent function as the output value function.

### CROSS-REFERENCE TO RELATED APPLICATIONS

This application is a continuation of International Application No. PCT/EP2021/052680, filed on Feb. 4, 2021, the disclosure of which is hereby incorporated by reference in its entirety.

### FIELD

This disclosure relates to automated reward shaping as part of reinforcement learning.

### BACKGROUND

Reinforcement learning (RL) offers the potential for autonomous agents to learn complex behaviours without the need for human intervention or input. RL has had notable success in a number of areas such as robotics, video games, and board games. Despite these achievements, deploying RL algorithms in many settings of interest remains a challenging task. A notable hurdle is that central to the success of RL algorithms is the requirement of a rich signal of the agent's performance. RL algorithms generally require a well-behaved reward function, which is an informative map to guide the agent towards its optimal policy.

In many settings of interest, for example physical tasks, such the Cartpole problem and Atari games, rich informative signals of the agent's performance are not readily available. For example, in the Cartpole Swing-up problem, as described in Camilo Andres Manrique Escobar, Carmine Maria Pappalardo, and Domenico Guida. “A Parametric Study of a Deep Reinforcement Learning Control System Applied to the Swing-Up Problem of the Cart-Pole”, Applied Sciences 10.24 (2020), p. 9013, the agent is required to perform a precise sequence actions to keep the pole upright and only receives a penalty if the pole falls. In Montezuma's revenge (Atari), the agent must find a set of distant collectable items and must perform subtasks in some prespecified order. In these settings, the reward signal provides little information. This generally leads to very poor sample efficiency and causes RL algorithms to struggle to learn or require large computational resources, creating a great need for solving these problems efficiently.

Reward-shaping (RS) is a method by which additional reward signals (shaping-rewards) are introduced during learning to supplement the reward signal from the environment. RS is a powerful method in RL for overcoming the problem of sparse, uninformative rewards and exploiting domain knowledge. RS is also an effective tool for encouraging exploration and inserting structural knowledge, each of which can dramatically improve learning outcomes.

However, RS relies on manually engineered shaping-reward (SR) functions whose construction is typically time-consuming and error-prone. It also requires domain knowledge which runs contrary to the goal of autonomous learning.

Potential based reward shaping (PB-RS), as described in Andrew Y Ng, Daishi Harada and Stuart Russell, “Policy invariance under reward transformations: Theory and application to reward shaping”, ICML. Vol. 99. 1999, pp. 278-287, aims to obtain a reward function that achieves a better performance without modifying the optimal policy for the underlying Markov decision process (MDP) which can be achieved by using a potential based reward function over the sate space. Later variants of PB-RS include important potential-based advice (PBA), which defines the potential function over the state-action space, the dynamic PB-RS approach, which introduces time in the potential function to allow dynamic reward shaping, the dynamic potential-based advice (DPBA), which converts a given reward function into a potential function, and more recently learning a potential function prior that fits a distribution of tasks and that can be later tuned to fit a specific task.

Curiosity based reward shaping aims to encourage the agent to explore states that are considered interesting in some way by giving an extra reward for visiting them. The simplest approach is using visitation counts. More sophisticated ways of measuring the novelty of a state have been introduced, such as using the prediction error of features of the visited states given by a random network, the prediction error of the next state given by a learned dynamics model, maximising the information gain about an agent's belief of environment dynamics, using heuristic metrics to determine how promising state is and more recently, by predicting a latent representation of skills. As opposed to potential based reward shaping, these methods tend to not be based or provide any theoretical insight or guarantee such as preserving the optimal policy for the underlying Markov decision process. They mainly concentrate on finding ways of visiting/exploring new states and crucially, often without considering the reward given by the environment to compute the extra curiosity reward.

Reward learning aims to learn or fine tune a reward function. One of the first attempts was aimed at learning a reward function using random search. Later methods used a gradient based approach, learning a reward function through meta-learning on a distribution of tasks and learning a shaping weight function to modulate a given reward function.

Current approaches to reward shaping have limitations. Firstly, adding shaping-rewards can change the optimisation problem, leading to generated policies that are completely irrelevant to the task. Poor choices of shaping-rewards can worsen the performance of the controller (even if the underlying problem is preserved). Furthermore, manually engineering shaping-rewards requires domain-specific knowledge, which defeats the purpose of autonomous learning.

Manually engineering such a term for a given task generally requires a large amount of time and domain-specific knowledge, which defeats the purpose of an autonomous learning method.

The first issue above can be addressed using PB-RS methods that ensure the stationary points of the optimization are preserved. Although PB-RS defines a condition which preserves the fundamentals of the problem, it does not offer a means of finding any such shaping-reward, thus the issue of which reward-shaping term to introduce remains. Additionally, the other issues above remain as generally unresolved challenges.

To improve learning, the correct reward-shaping term should be obtained in addition to learning the policy that maximizes the agent's modified objective. Attempts at optimizing the reward-shaping term simultaneously to learning the agent's policy face potential convergence issues, since for the agent, the reward signal for each state action pair is changing at each iteration (thus violating the requirement within reinforcement learning of a stationary environment). Moreover, while the reward function is being shaped during training, it can be corrupted with inappropriate signals thus hindering the agent's ability to learn.

More recently, bilevel approaches have been put forward to tackle the problem of learning the shaping-reward in an automated fashion. This approach however generally requires that a reasonable shaping-reward function be known in advance. Additionally, the bilevel training approach is consecutive, as opposed to concurrent, requiring much more training time to compute the desired shaping reward function.

It is desirable to develop an improved method that overcomes these problems.

### SUMMARY

According to one aspect, there is provided a machine learning apparatus comprising one or more processors configured to form an output value function for achieving a predetermined objective by receiving an initial environment state, an initial state of a first agent function and an initial state of a second agent function; and iteratively performing the steps of (i) implementing a current state of the first agent function in dependence on a current environmental state to form a subsequent environmental state and a first reward; (ii) a first determining step comprising determining by means of the second agent function whether to use a second reward; (iii) if that determination has a negative outcome, refining the first agent function in dependence on the first reward; and if that determination has a positive outcome, computing the second reward according to a predetermined reward function and refining the first agent function in dependence on the first reward and the second reward; (iv) refining the second agent function in dependence on a performance of the first agent function in meeting the predetermined objective; and (v) adopting the subsequent environmental state as the current environmental state; and subsequently: outputting the current state of the first agent function as the output value function.

The apparatus can allow for automated reward-shaping which requires no a priori human input.

The predetermined objective may be a desired behaviour, or a set of responses to a range of inputs, or the ability to generate such responses. The responses may have predetermined effects or meet predetermined criteria. The inputs may be environmental inputs. Thus, the output value function may be capable of receiving inputs from the range of inputs and generating responses thereto, the responses satisfying the predetermined objective.

The subsequent environmental state may be a state formed by the first agent function taking the current environmental state as input. The subsequent environmental state may be formed by one or more iterations of the first agent function taking the current environmental state as initial input.

The performance of the first agent function in meeting the predetermined objective may be formed in dependence on the subsequent environmental state and/or the current environmental state. The performance may be a measure of whether and/or the extent to which the subsequent environmental state better fits the predetermined objective than does the current environmental state.

The determining step may comprise computing a binary value representing whether or not to use the second reward. The use of a binary value can permit the algorithm to be simplified, for example by avoiding the need to compute the second reward when it is not to be employed.

The step of refining the second agent function may be performed in dependence on an objective function which comprises a negative cost element if on a respective iteration the determination of whether to use the second reward has a positive outcome. This can helpfully influence the learning of the second agent function.

The step of refining the second agent function may comprise a second determining step, comprising determining whether the subsequent environmental state formed on the respective iteration is in a set of relatively infrequently visited states, and wherein the step of refining the second agent function is performed in dependence on an objective function, which comprises a positive reward element if on a respective iteration that determination has a positive outcome. This can helpfully influence the learning of the second agent function.

The one or more processors may be configured to, if the outcome of the first determining step is positive, refine the first agent function in dependence on the sum of the first reward and the second reward. In this situation, both rewards can be used to help train the first agent function.

The reward function may be such that summing the first reward and the second reward preserves pursuit of the objective. This can help avoid the system described above reinforcing learning of an unwanted objective.

The one or more processors may be configured to, on each iteration, compute the second reward only if the outcome of the first determining step is positive. This can make the process more efficient.

The first reward may be determined in dependence on the subsequent environmental state. This can help the system learn to better form the subsequent environmental state on future iterations.

According to a second aspect, there is provided a machine learning apparatus comprising one or more processors configured to form an output value function for achieving a predetermined objective by iteratively learning successive candidates for the output value function in dependence on: (i) in each iteration a first reward dependent on an environmental state determined by a current state of the output value function; and (ii) in at least some iterations a second reward formed by a second value function; the machine learning apparatus being configured to learn the second value function over successive iterations.

According to another aspect, there is provided a computer-implemented machine learning method for forming an output value function, the method comprising: receiving an initial environment state, an initial state of a first agent function and an initial state of a second agent function; and iteratively performing the steps of: (i) implementing a current state of the first agent function in dependence on a current environmental state to form a subsequent environmental state and a first reward; (ii) a first determining step comprising determining by means of the second agent function whether to use a second reward; (iii) if that determination has a negative outcome, refining the first agent function in dependence on the first reward; and if that determination has a positive outcome, computing the second reward according to a predetermined reward function and refining the first agent function in dependence on the first reward and the second reward; (iv) refining the second agent function in dependence on a performance of the first agent function in meeting the predetermined objective; and (v) adopting the subsequent environmental state as the current environmental state; and subsequently: outputting the current state of the first agent function as the output value function.

This method can allow for automated reward-shaping which requires no a priori human input.

According to a further aspect, there is provided a computer implemented machine learning method for forming an output value function for achieving a predetermined objective, the method comprising: iteratively learning successive candidates for the output value function in dependence on: (i) in each iteration a first reward dependent on an environmental state determined by a current state of the output value function; and (ii) in at least some iterations a second reward formed by a second value function; and learning the second value function over successive iterations.

According to a further aspect, there is provided a computer readable medium storing in non-transient form a set of instructions for causing one or more processors to perform the method described above. The method may be performed by a computer system comprising one or more processors programmed with executable code stored non-transiently in one or more memories.

According to a further aspect, there is provided a computer-implemented data processing apparatus configured to receive an input and process that input by means of a function outputted as an output value function by apparatus as set out above.

The input may be an input sensed from an environment in which the data processing apparatus is located. The data processing apparatus may comprise one or more sensors whereby the input is sensed.

### BRIEF DESCRIPTION OF THE FIGURES

The present disclosure will now be described by way of example with reference to the accompanying drawings. In the drawings:

FIG. 1 shows an example of a condensed algorithm describing the workflow of one aspect of the method.

FIG. 2 shows an example of a more detailed algorithm describing the workflow of one aspect of the method.

FIG. 3 shows a schematic illustration of an overview of an embodiment of the present disclosure.

FIG. 4 schematically illustrates an example of the flow of events that occurs when Player 2 decides to add an additional reward at states s₃ and s₄.

FIG. 5 schematically illustrates an exemplary implementation using a maze setting with one high reward goal state (+1) and one low reward goal state (+0.5).

FIG. 6 summarises an example of a computer-implemented machine learning method for forming an output value function.

FIG. 7 summarises an example of a computer implemented machine learning method for forming an output value function for achieving a predetermined objective.

FIG. 8 shows a schematic diagram of a computer apparatus configured to implement the method described herein and some of its associated components.

### DETAILED DESCRIPTION

Described herein is a non-zero-sum game framework that is able to design shaping-reward functions using multi-agent reinforcement learning and a switching control framework in which the shaping reward function is activated at a subset of states. The framework can also discover states to add rewards and generate subgoals.

The framework can learn to construct a shaping-reward function that is tailored to the setting and may guarantee convergence to higher performing RL policies.

A second agent (Player 2) can seek to encourage the controller to explore sequences of unvisited states by learning where in the state space to add reward signals to the system. This enables Player 2 to introduce an informative sequence of rewards along subintervals of trajectories. Using this form of control can lead to a low complexity problem for Player 2, since the decision it faces is to decide only which subregions to add additional rewards.

The inclusion of a second agent also allows the adaptive learner to achieve subgoals. Subgoals may be considered as intermediate goal states that help the controller learn complete optimal trajectories. Hence, in this implementation, the goal of Player 2 is to learn where to place additional rewards for the controller. This eliminates the sparsity problem that can arise and enables the controller to learn where to explore. This includes exploring beyond states that deliver positive but small rewards in a sparse reward setting. The controller can now learn to solve the easier objective, which includes both the intrinsic rewards and the shaping-reward function.

In the automated RS framework described herein, the SR function is generally constructed in a stochastic game between two agents. In this setting, one agent can learn both: (i) which states to add additional rewards; and (ii) their optimal magnitudes, and another agent can learn the optimal policy for the task using the shaped rewards.

Therefore, as mentioned above, a second player (referred to below as P2) is added along with an additional shaping-reward whose output (at a state) is decided by P2.

The policy that P2 uses can be determined by options, which generalise primitive actions to include selection of sequences of actions. This will be described in more detail later.

Other prior automated RS methods require sequential updating of the shaping reward function after the RL controller has updated. This procedure is very slow. Previous attempts at concurrent updating have been met with convergence issues which fail.

Introducing a new player produces a nonzero-sum stochastic game. P2 has a different objective to P1 (which enables P2 to help P1 to learn). Nonzero-sum games are generally intractable, however the framework described herein has a special structure which is a type of stochastic potential game (SPG). In a preferred embodiment, the game also has other special properties, specifically it is an ARAT game and a single controller stochastic game.

The framework, which can easily adopt existing RL algorithms, therefore learns to construct an SR function that is tailored to the task and can help to ensure convergence to higher performing policies for the given task. In some embodiments, the method may exhibit superior performance against state-of-the-art RL algorithms.

The RS issues encountered in prior methods are addressed by introducing a framework in which the additional agent learns how to construct the S function. This results in a two-player nonzero-sum stochastic game (SG), an extension of a Markov decision process (MDP) that involves two independent learners with distinct objectives.

In this game, an agent (controller) seeks to learn the original task set by the environment and the second agent (P2) that acts in response to the controller's actions, seeks to shape the controller's reward. This constructs an SR function that is tailored to the task at hand without the need for domain knowledge or manual engineering.

The framework therefore accommodates two distinct learning processes each delegated to an agent.

Further details of the process will now be described.

In RL, an agent sequentially selects actions to maximise its expected returns. The underlying problem is typically formalised as an MDP [symbol] S, A, P, R, γ [symbol] , where S is the set of states, A is the discrete set of actions, P:S×A×S→[0,2] is a transition probability function describing the system's dynamics, R:S×A→ [symbol] is the reward function measuring the agent's performance and the factor γ∈[0,1] specifies the degree to which the agent's rewards are discounted over time.

At each time t∈0,1, . . . , the system is in state sₜ∈S and the agent chooses an action aₜ∈A which transitions the system to a new state sₜ₊₁˜P(·|sₜ, aₜ) and produces a reward π(sₜ, aₜ). A policy π:S×A→[0,1] is a probability distribution over state-action pairs where π(a|s) represents the probability of selecting action a in state s. The goal of an RL agent is to find an optimal policy π\hat{ }∈Π that maximises its expected returns as measured by the value function:

ν^{π}(s)= [symbol] [Σₜ₌₀^{∞}γ^{t}R(sₜ,aₜ)|aₜ˜π(·|sₜ)].

This is referred to herein as Problem (A).

In settings in which the reward signal is sparse, R is not informative enough to provide a signal from which the controller can learn its optimal policy. To alleviate this problem, reward shaping adds a prefixed term F:S→ [symbol] to the agent's objective to supplement the agent's reward. This augments the objective to:

ν^{π}(s)= [symbol] [Σₜ₌₀^{∞}γ^{t}{R(sₜ,aₜ)+F(sₜ)}|aₜ˜π(·|sₜ)].

A two-player SG is an augmented MDP involving two players {1,2}=:N that simultaneously take actions over many (possibly infinite) rounds. Formally, an SG is described by a tuple G= [symbol] N, S, (Aᵢ)_{i∈N}, P, (Rᵢ)_{i∈N}, γ [symbol] where the new elements are Aᵢ which is the discrete action set and Rⱼ: [symbol] ×(xᵢ₌₁² [symbol] )→ [symbol] , which is a reward function for each player i∈N. In an SG, at each time t∈0, 1 . . . , the system is in state sₜ∈S and each player i∈N takes an action aⁱₜ ∈Aᵢ. The joint action aₜ=(a¹ₜ, a²ₜ)∈A:=×²ᵢ₋₁Aᵢ produces an immediate reward Rᵢ(sₜ, aₜ) for player i∈N and influences the next state transition which is chosen according to the probability function P:S×A×S→[0,1]. Using a strategy πⁱ to select its actions, each Player i seeks to maximise its individual expected returns as measured by its value function:

νᵢ^{π}^{ⁱ}^{,π}^{^{j≠i}}(s)= [symbol] [Σₜ₌₀^{∞}γ^{t}Rᵢ(sₜ,aₜ)|aₜ˜(πⁱ,π^{j≠i})].

A Markov strategy is a policy πⁱ:S×Aᵢ→[0,1] which requires as input only the current system state (and not the game history or the other player's action or strategy).

Finding an appropriate term F can be a significant challenge. Poor choices of F can hinder the agent's ability to learn its optimal policy. Moreover, attempts to learn F present an issue of convergence given that there are two concurrent learning processes.

To tackle these challenges, the problem is formulated in terms of an SG between an RL controller (Player 1) and a second agent (Player 2). The goal for Player 2 is to now learn to construct a useful SR function that enables the controller to learn effectively.

In particular, Player 2 learns how to choose the output of the SR function at each state with the aim of aiding the controller's learning process. At each state, Player 2 chooses action which is an input of F whose output determines the shaped-reward signal for the controller. Simultaneously, the controller performs an action to maximise its total reward given its observation of the state This leads to a SG—an augmented MDP which now involves two agents that each take actions.

Formally, the SG is defined by a tuple G= [symbol] {1,2}, S, A, B, P, R\hat{ }1, R\hat{ }2, γ [symbol] , where the new elements are B which is the action set for each player 2, R\hat{ }₁:=R+F which is the new Player 1 reward function where the SR F:B×B→ [symbol] is now augmented to accommodate the Player 2 action (since the Player 2 policy has state dependency, it is easy to see that a state input of F is not beneficial) and lastly, the function ^{R}\hat{ }₂:S×A×B→ [symbol] is the one-step reward for Player 2. The transition probability matrix P:S×A×S→[0,1] takes the state and the Player 1 action as inputs (but not the action of Player 2!). To decide its actions, Player 2 uses a Markov policy π_{ν}²:S×B→[0,1] parameterised by ν∈V, for determining the value of the reward-shaping signal supplied to the controller. Since the Player 1 policy can computed by any RL algorithm, the framework easily adopts any existing RL learning method for the controller.

In what follows, the index ν is suppressed on the Player 2 policy π_{ν}² and written π². The notation Π:=×²ᵢ₌₁Πⁱ is also employed and (aⁱ, a⁻ⁱ)=(aⁱ, a^{j})∈A×B, i, j∈{1,2}, i6= [symbol] denotes any finite normed vector space.

Having described the method by which the SR is constructed by Player 2, it will now be discussed how the complexity of the Player 2 learning problem can be reduced.

The problem for Player 2 described thus far involves determining the additional reward to be supplied to the controller at each state. This is computationally challenging in settings with large state spaces. To avoid this, in a preferred embodiment, Player 2 first gets to decide which states to t fits additional rewards for Player 1 (introduced through F) through a switch I: [symbol] →{0, 1}. This leads to an SG in which, unlike classical SGs, Player 2 now uses switching controls to perform its actions. Thus Player 2 is tasked with learning how to modify the rewards only in states that are important for guiding the controller to its optimal policy.

{τk}_{k>0} denotes the set of times that a switch takes place (later described in more detail). With this, the new Player 1 objective is:

$${v}_{1}^{π , {π}^{2}} ( z ) = [ {\sum }_{t = 0}^{∞} {γ}^{t} \{ R ( {s}_{t} , {a}_{t} ) + F ( {a}_{t}^{2} , {a}_{t - 1}^{2} ) I ( t ) \} , \qquad ( 1 )$$

$$z ( t ) := ( {s}_{t} , {I}_{t} ) ∈ δ \times \{ 0 , 1 \} ,$$

where aₜ˜π, aₜ²˜π_{ν}² and I(t)=Iₜ=I₀1_{τ1<t≤τ2}+ . . . and Iₜ₊₁=1−Iₜ, which is the switch for the SRs from Player 2. The switching times {τₖ} are rules that depend on the state.

Now Player 2 decides whether to turn on the SR function F or not and which policy {π_{ν}}_{ν∈V} to use to select its actions that affect the SR function. The decision to turn on F at a state and subsequently, which policy to select are both determined by a (categorical) policy g₂:S×V→{0,1}. With this, it can be seen that the sequence of times {τₖ}_{k>0} is τₖ=inf{t>τₖ₋₁|sₜ∈S, ν∈V, g₂(ν|sₜ)>0} (Precisely; {τₖ}_{k≥0} are preferably constructed using stopping times).

Below is a summary of events.

At a time k∈0,1 . . .
Both players make an observation of the state sₖ∈S.
Player 1 takes an action aₖ sampled from its policy c.
Player 2 decides whether or not to activate the SR using g₂:S×V→{0,1}:
If g₂(ν∈V|sₖ)=0 for all ν∈V:
   X The switch is not activated (I(t=k)=0). Player 1 receives a reward r˜R(sₖ, aₖ) and the system transitions to the next state sₖ₊₁.
If g₂(ν∈V|sₖ)=1 for some ν∈V:
   Player 2 takes an action a²ₖ sampled from its policy π_{ν}².
   X The switch is activated (I(t=k)=1), Player 1 receives a reward R(sₖ, aₖ)+F(a²ₖ, a²ₖ₋₁)×1 and the system transitions to the next state sₖ₊₁.

Set τ₀≡0 and a_{τ}_{ₖ}²≡0, ∀k∈ [symbol] (note the terms a_{τ}_{ₖ}²+1, . . . , a_{τ}_{ₖ₊₁}²−1 remain non-zero) and a²ₖ≡0 ∀k≤0.

\hat{R}₁(zₜ,aₜ,aₜ²,aₜ₋₁²):=R(sₜ,aₜ)+F(aₜ²,aₜ₋₁²)Iₜ where zₜ≡(sₜ,Iₜ))∈S×{0,1}.

The goal of Player 2 is to guide the controller to learn to maximise its own objective (given in Problem A). As discussed earlier, the SR F can be activated by switches controlled by Player 2. In order to induce Player 2 to selectively choose when to switch on the shaping reward, each switch activation incurs a fixed minimal cost for Player 2. The cost has two main effects. Firstly, it ensures that the information-gain from encouraging exploration in the given set of states is sufficiently high to merit activating the stream of rewards. Secondly, it reduces the complexity of the Player 2 problem, since its decision space is to determine which subregions of the S it should activate rewards (and their magnitudes) to be supplied to the controller.

Given these remarks, the objective for Player 2 is given by:

$${v}_{2}^{π , {π}^{2}} ( z ) = {π , {π}^{2}}_{} [ {\sum }_{t = 0}^{∞} {γ}^{t} ( {\hat{R}}_{1} + {\sum }_{k \geq 1}^{∞} c ( {I}_{t} , {I}_{t - 1} ) {δ}_{{τ}_{2 k - 1}}^{t} + L ( {s}_{t} ) ) ] - {π}_{} [ {\sum }_{t = 0}^{∞} {γ}^{t} R ( {s}_{t} , {a}_{t} ) ] , \qquad ( 2 )$$

$$∀ z ≡ ( {s}_{0} , {I}_{0} ) ) ∈ δ \times \{ 0 , 1 \} .$$

The difference Eπ,π2[R\hat{ }1]−Eπ[R] encodes the Player 2 agenda, namely to induce improved performance by the controller. The function c:N×N→ [symbol] <₀ is a strictly negative cost function which is modulated by δ_{τ}_{₂ₖ₋₁}^{t} which restricts the costs to points at which the SR is activated. Lastly, the term L:S? [symbol] is a Player 2 bonus reward for when the controller visits infrequently visited states. For this term, there are different possibilities. Model prediction error terms and count-based exploration bonuses (in discrete state spaces) are examples. With this, Player 2 can construct a SR function that supports learning for the controller. This avoids introducing a fixed function to the Player 1 objective. Though Player 2 modifies the controller's reward signals, the framework can preserve the optimal policy and underlying MDP of Problem A.

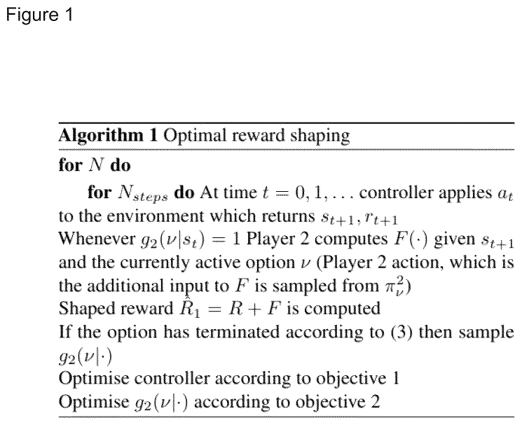

The game G is solved using a multi-agent RL algorithm. A condensed example of the algorithm's pseudocode is shown in FIG. 1. The algorithm comprises two independent procedures. Player 2 updates its own policy that determines the value of the SR at each state while the controller learns its policy. The preferred implementation for Player 2 uses options which generalise primitive actions to include selection of sequences of actions. If an option ν E Vis selected, the policy ev is used to select actions until the option terminates (which it does according to (3) below). If the option has not terminated, an action is then selected by the policy KV.

To enable Player 2 to encourage adaptive exploration of the states during learning, as in RND (as described in Yuri Burda et al. “Exploration by random network distillation”, arXiv preprint arXiv:1810.12894, 2018), the following is constructed:

L by L(sₜ):=∥\hat{f}−f∥₂²

where f is a random initialised network which is the target network that is fixed during learning and f is the prediction function that is consecutively updated during training.

F is implemented as F(t⁰, π_{ν}(sₜ0), t, π_{ν}(sₜ))=γφ(t⁰, π_{ν}(·|sₜ0))−φ(t, π_{ν}(·|sₜ)), where ν∈R^{m} is a discrete option implemented as a vector for which only one component is one and other components are zeros and m is the number of options to be learned. \hat{f}, f are realvalued multi-head functions (as in Yuri Burda et al. “Exploration by random network distillation”, arXiv preprint arXiv:1810.12894, 2018) but now modified to accommodate actions.

There are various possibilities for the termination times {τ₂ₖ} (recall that {τ₂ₖ₊₁} are the times which the SR F is switched on using g₂). One is for Player 2 to determine the sequence. Another is to build a construction of {τ₂ₖ} that directly incorporates the information gain that a state visit provides. In this case, let w be a random variable with support {0,1} with Pr(w=1)=p and Pr(w=0)=1−p where p∈]0, 1]. Then for any k=1,2, . . . , let ΔL(s_{τk}):=L(s_{τk})−L(s_{τk-1}). Set:

$$I ( {s}_{{τ}_{2 k + 1} + j} ) = \{ \begin{matrix}I ( {s}_{{τ}_{2 k + 1}} ) , if w Δ L ( {s}_{{τ}_{k + j}} ) > 0 , \\ I ( {s}_{{τ}_{2 k + 2}} ) , w Δ L ( {s}_{{τ}_{k + j}} ) \leq 0.\end{matrix} \qquad ( 3 )$$

Recall that {τ₂ₖ₊₁}_{k≥0} are the set of times at which the SR F is activated where I denotes the switch coefficient on F. Then ∀k≥0 we have I(s_{τ2k+1})=1, moreover if after j time steps after F is switched on it remains activate then I(s_{τ2k+1+j})=I(s_{τ2k+1}). Recall also that {_{τ2k}}_{k≥0} are the times in which F is deactivated. This means that if F is deactivated at exactly the 1^{th} time-step then I(s_{τ2k+1+j})=I(s_{τ2k+2}). It can be seen that the construction leads to a termination when either the random variable w attains a 0 or when the exploration bonus in the current state is lower than that of the previous state.

Constructing the shaping reward online therefore involves two learning processes: Player 2 learns the SR function while the controller (Player 1) learns to solve its task given the reward signal from the environment and the shaping reward.

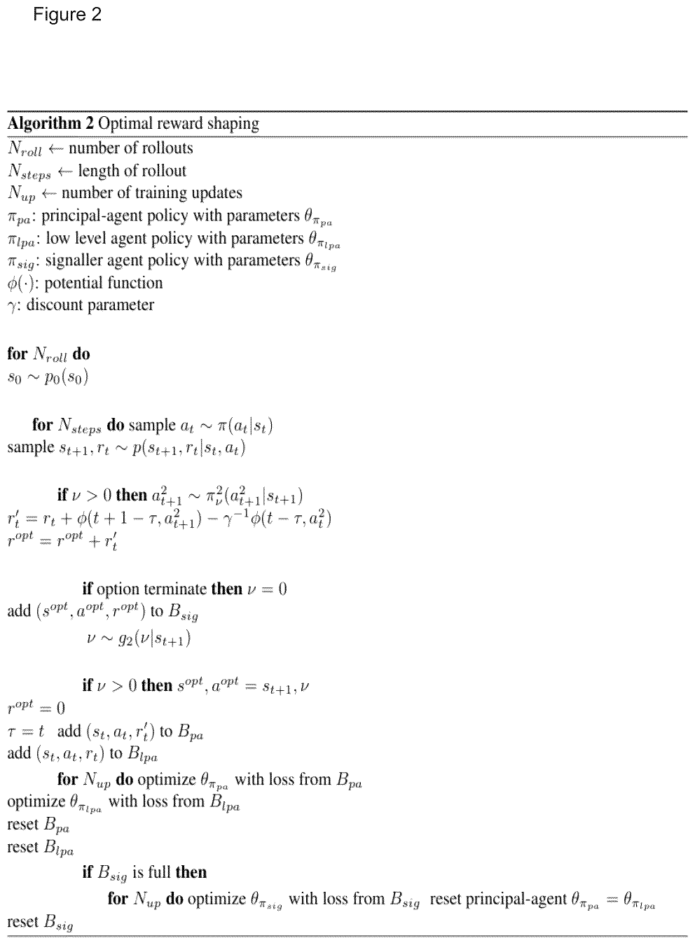

The more detailed algorithm 2 shown in FIG. 2 describes the workflow. The algorithm comprises two independent procedures. Player 2 updates its own policy that determines the value of the shaping-reward at each state while the controller learns its policy. The implementation for Player 2 uses options which generalise primitive actions to include selection of sequences of actions. If an option ν∈V is selected, the policy π_{ν} is used to select actions until the option terminates. If the option has not terminated, an action is then selected by the policy π_{ν}.

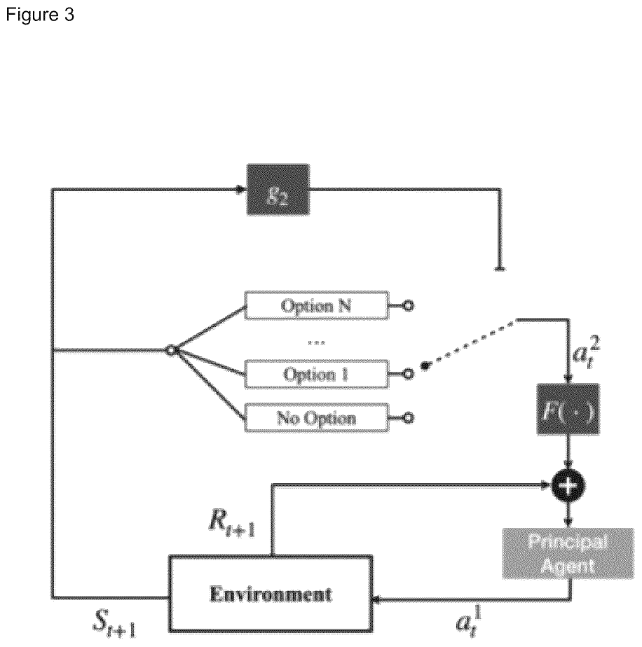

FIG. 3 shows a schematic diagram of an embodiment of the present disclosure. Player 2 decides whether to turn on the shaping reward function F or not and which policy {π_{ν}}_{ν∈V} to use to select its actions that affect the shaping reward function. The decision to turn on F at a state and subsequently which policy to select are both determined by a policy g₂:S×V→{0, 1}.

The output (at a state) of the additional shaping-reward is decided by P2. P2 makes observations of the state selects actions aₜ²˜π². P2's actions are inputs to shaping reward function F(bₜ, b_{{t-1}}) where bₜ:=(t, aₜ²).

The Player 1 (P1) objective is now:

$${v}_{1}^{π , {π}^{2}} ( z ) = [ {\sum }_{t = 0}^{∞} {γ}^{t} \{ R ( {s}_{t} , {a}_{t} ) + F ( {b}_{t} , {b}_{t - 1} ) \} ]$$

Further, the framework also learns which states to add additional rewards. Adding rewards incurs a cost for P2. The presence of the cost means that P2 adds rewards to states that are required to attract the controller to points along the optimal trajectory. This may advantageously naturally induce subgoal discovery. States to which rewards are added can be characterised as below:

τₖ=inf{τ>τₖ₋₁| [symbol] ^{π,π}^{_{ν}}^{²}ν₂^{π,π}^{_{ν}}^{²}(z)=ν₂^{π,π}^{²}(z)}.

Similarly P2's switching policy g₂ can be given by:

g₂(ν|sₜ)=H( [symbol] ^{π,π}^{_{ν}}^{²}ν₂^{π,π}^{_{ν}}^{²}−ν₂^{π,π}^{²})(z) where H is the Heaviside function.

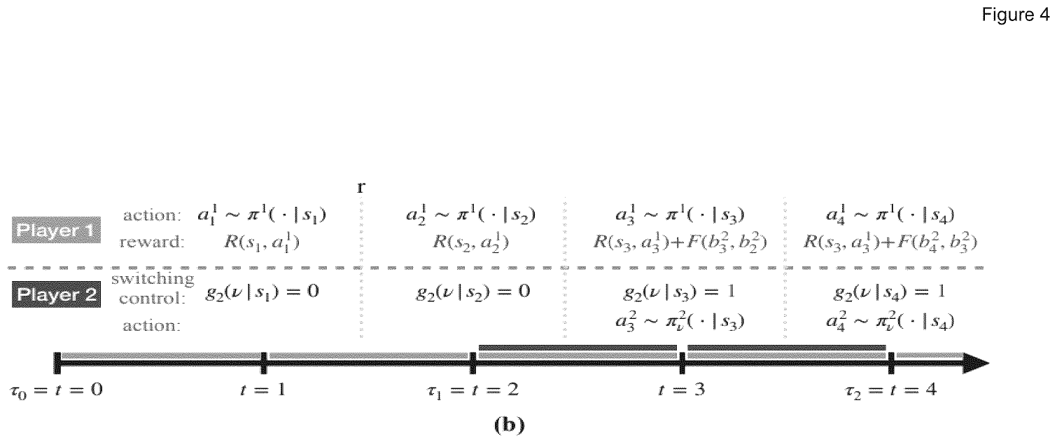

FIG. 4 diagram illustrates the flow of events when Player 2 decides to add an additional reward at states s₃ and s₄.

Deciding the magnitude of the reward to add at every state can be very costly (and in some cases also redundant). A better way is for P2 to decide which states to add a reward (at all) and add streams of rewards across consecutive states. Therefore the shaping-reward F is conveniently modulated by the switch I( ). For this P2, decides which states it should switch on the rewards. This is schematically illustrated in FIG. 4.

P2 decides which states to add a reward (at all) and add streams of rewards across consecutive states. Therefore the shaping-reward F is modulated by switch I( ):

$${v}_{1}^{π , {π}^{2}} ( z ) = [ {\sum }_{t = 0}^{∞} {γ}^{t} \{ R ( {s}_{t} , {a}_{t} ) + F ( {b}_{t} , {b}_{t - 1} ) I ( t ) \} ]$$

$$t = 0 , 1 , … , I ( t ) ≡ {I}_{t} = {I}_{0} {1}_{t \leq {τ}_{1}} + {I}_{1} {1}_{{τ}_{1} < t \leq {τ}_{2}} + … {I}_{t + 1} = 1 - {I}_{t}$$

For this, P2 decides which states it should switch on the rewards.

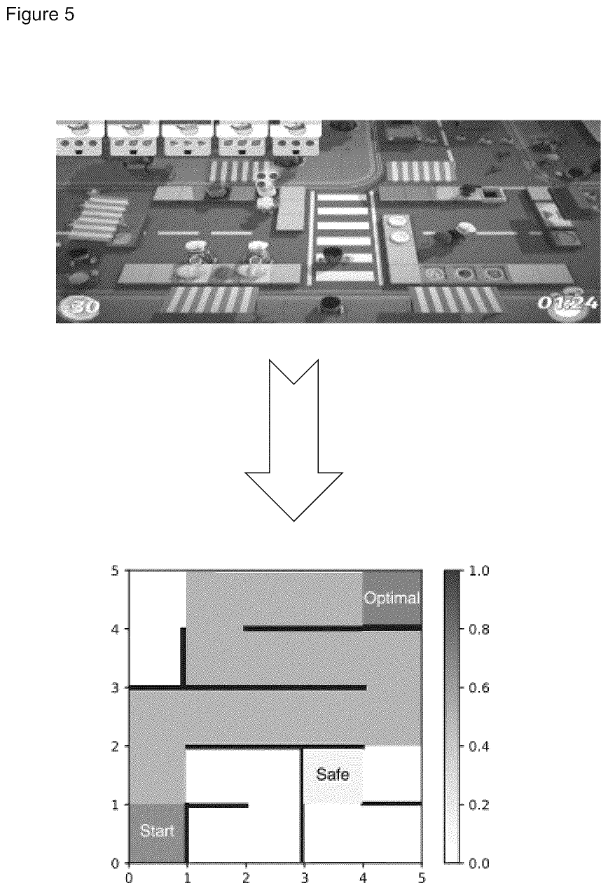

In one example of the reward-shaping aspect of the present disclosure, as illustrated in FIG. 5, consider a maze setting with one high reward goal state (+1) and one low reward goal state (+0.5). In this example, all other states have 0 rewards, so the setting is sparse. Agent P1 begins at start state Its goal is to maximise its rewards, i.e. find +1. Since the rewards are discounted to maximise its rewards, it should arrive at its desired state in the shortest time possible. P2 adds rewards to the relevant squares (only). The squares to which P2 adds rewards are shown in light grey/unshaded (the lighter the colour the higher the probability of adding rewards).

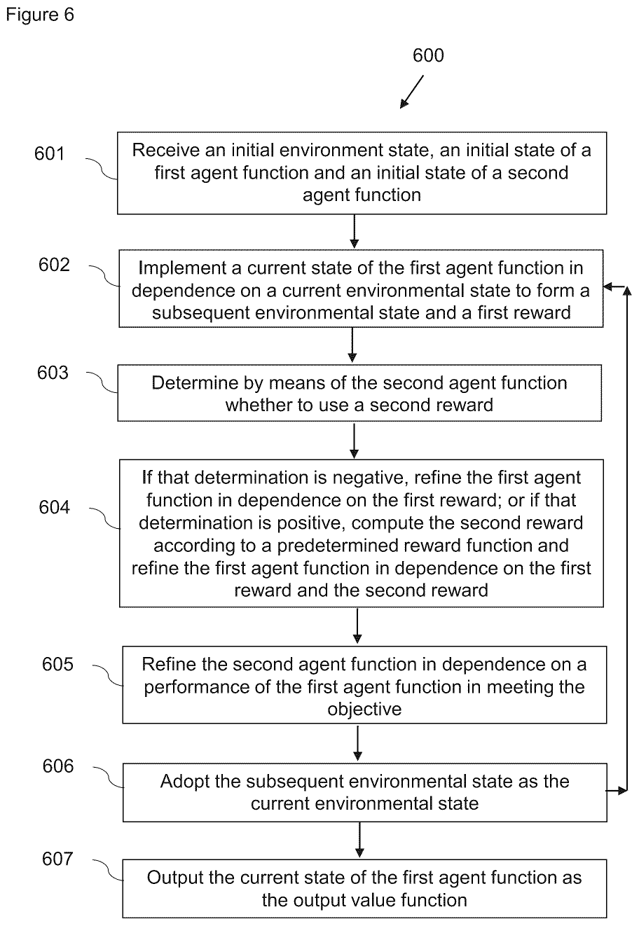

FIG. 6 summarises an example of a computer-implemented method 600 for forming an output value function. The method comprises, at step 601, receiving an initial environment state, an initial state of a first agent function and an initial state of a second agent function. Then, the steps 602-606 are iteratively performed. At step 602, the method comprises implementing a current state of the first agent function in dependence on a current environmental state to form a subsequent environmental state and a first reward. At step 603, a first determining step comprises determining by means of the second agent function whether to use a second reward. At step 604, if that determination has a negative outcome, the first agent function is refined in dependence on the first reward; and if that determination has a positive outcome, the second reward is computed according to a predetermined reward function and the first agent function is refined in dependence on the first reward and the second reward. At step 605, the method comprises refining the second agent function in dependence on a performance of the first agent function in meeting the predetermined objective. At step 606, the method comprises adopting the subsequent environmental state as the current environmental state. The steps 602-606 may be performed until convergence according to some predefined criteria. Subsequently, at step 607, the current state of the first agent function is output as the output value function.

The subsequent environmental state may be a state formed by the first agent function taking the current environmental state as input. The subsequent environmental state may be formed by one or more iterations of the first agent function taking the current environmental state as initial input.

The performance of the first agent function in meeting the predetermined objective may be formed in dependence on the subsequent environmental state and/or the current environmental state. The performance may be a measure of whether and/or the extent to which the subsequent environmental state better fits the predetermined objective than does the current environmental state.

In some embodiments of the method, the determining step may comprise computing a binary value representing whether or not to use the second reward. This can permit the algorithm to be simplified, for example by avoiding the need to compute the second reward when it is not to be employed.

The step of the method of refining the second agent function may be performed in dependence on an objective function which comprises a negative cost element if on a respective iteration the determination of whether to use the second reward has a positive outcome. This can helpfully influence the learning of the second agent function.

The step of refining the second agent function may comprise a second determining step comprising determining whether the subsequent environmental state formed on the respective iteration is in a set of relatively infrequently visited states and wherein the step of refining the second agent function is performed in dependence on an objective function which comprises a positive reward element if on a respective iteration that determination has a positive outcome. This can helpfully influence the learning of the second agent function.

In some implementations, if the outcome of the first determining step is positive, the first agent function is refined in dependence on the sum of the first reward and the second reward. In this situation, both rewards can be used to help train the first agent function.

In some implementations, the reward function may be such that summing the first reward and the second reward preserves pursuit of the objective. This can help avoid the system described above reinforcing learning of an unwanted objective.

In some implementations, on each iteration, the second reward may be computed only if the outcome of the first determining step is positive. This can make the process more efficient.

In some implementations, the first reward may be determined in dependence on the subsequent environmental state. This can help the system learn to better form the subsequent environmental state on future iterations.

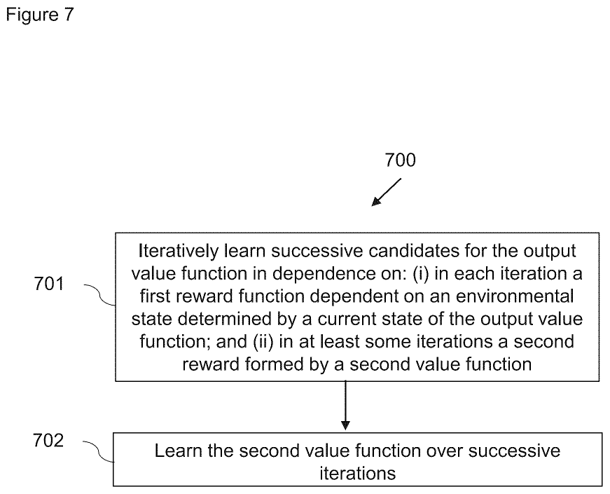

FIG. 7 shows an example of a further computer implemented machine learning method for forming an output value function for achieving a predetermined objective. The method comprises, at step 701, iteratively learning successive candidates for the output value function in dependence on: (i) in each iteration a first reward dependent on an environmental state determined by a current state of the output value function; and (ii) in at least some iterations a second reward formed by a second value function. At step 702, the method comprises learning the second value function over successive iterations.

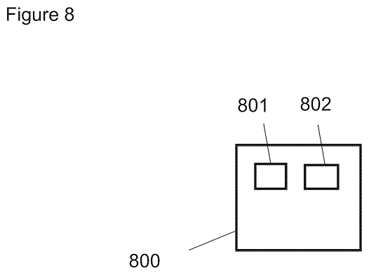

FIG. 8 shows a schematic diagram of a computer apparatus 800 configured to implement the computer implemented method described above and its associated components. The apparatus may comprise a processor 801 and a non-volatile memory 802. The apparatus may comprise more than one processor and more than one memory. The memory may store data that is executable by the processor. The processor may be configured to operate in accordance with a computer program stored in non-transitory form on a machine readable storage medium. The computer program may store instructions for causing the processor to perform its methods in the manner described herein.

The processor 801 can implement a data processing apparatus configured to receive an input and process that input by means of a function outputted as an output value function by apparatus as set out above. The input may be an input sensed from an environment in which the data processing apparatus is located. The data processing apparatus may comprise one or more sensors whereby the input is sensed.

The SG formulation described herein confers various advantages. The SR function is constructed fully autonomously. The game also ensures the SR improves the controller's performance unlike RS methods that can lower performance. By learning the SR function while the controller learns its optimal policy, Player 2 learns to facilitate the controller's learning process and improve outcomes. By choosing the new rewards, Player 2 can generate subgoals that decompose complex tasks into learnable subtasks. It can also encourage complex exploration paths. Convergence of both learning processes is guaranteed so the controller finds the optimal value function for its task. Player 2 can construct the SR according to any consideration. This allows the framework to induce various behaviours, such as exploration and subgoal discovery.

Constructing a successful two-player framework for learning additional rewards requires overcoming several obstacles. Firstly, the task of optimising the shaping reward at each state leads to an expensive computation (for Player 2) which can become infeasible for problems with large state spaces. To resolve this, in the SG described herein, Player 2 uses a type of control known as switching controls (Erhan Bayraktar and Masahiko Egami. “On the onedimensional optimal switching problem”, Mathematics of Operations Research 35.1 (2010), pp. 140-159) to determine the best states to apply an SR. Crucially, now the expensive task of computing the optimal shaping reward is reserved for only a subset of states leading to a low complexity problem for Player 2. Additionally, this method enables Player 2 to introduce an informative sequence of rewards along subintervals of trajectories.

Secondly, solving SGs involves finding a fixed point in which each player responds optimally to the actions of the other. In the SG framework described herein, this fixed point describes a set of stable policies for which Player 2 introduces an optimal SR and, with that, Player 1 executes an optimal policy for the task.

Moreover, there is a fixed point solution of the SG and the polynomial time convergence of the learning method. This can help to ensure that Player 2 learns the optimal SR function that improves the controller's performance and can help to ensure that the controller learns the optimal policy for the task.

Implementations of the method described herein may solve at least the following problems.

Embodiments of the present disclosure can allow for an automated reward-shaping method which requires no a priori human input. The two-agent reward-shaping game framework can allow for concurrent update. The framework may also lead to convergence guarantees with concurrent updates. The described switching control formulation reduces the complexity of the problem, enabling tractable computation, and the approach may allow for two player game of switching control on one-side.

The approach may provide shaped-rewards without the need for expert knowledge or human engineering of the additional reward term. The shaped-reward function constructed in the framework described herein can conveniently be tailored specifically for the task at hand.

Since the shaped-reward function is generated from a learned policy for Player 2, it is able to capture complex trajectories that include subgoals and can encourage exploration in potentially fruitful areas of the state space.

The method may preserve the optimal policy of the problem, enabling the agent to find the relevant optimal policy for the task.

The stochastic game formulation described herein can lead to convergence guarantees, which are extremely important in any adaptive methods.

The method may help to ensure that the controller's performance is improved, with the reward shaping term unlike existing reward shaping methods that can worsen performance.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present disclosure may consist of any such individual feature or combination of features. In view of the foregoing description it will be evident to a person skilled in the art that various modifications may be made within the scope of the disclosure.

What is claimed is:

1. A machine learning apparatus, the machine learning apparatus comprising one or more processors configured to:
form an output value function for achieving a predetermined objective by receiving an initial environment state, an initial state of a first agent function, and an initial state of a second agent function;
iteratively perform the steps of:
(i) implementing a current state of the first agent function in dependence on a current environmental state to form a subsequent environmental state and a first reward;
(ii) a first determining step comprising determining, using the second agent function, whether to use a second reward;
(iii) in a condition where that first determining step has a negative outcome, refining the first agent function in dependence on the first reward; and otherwise in a condition where the first determining step has a positive outcome, computing the second reward according to a predetermined reward function and refining the first agent function in dependence on the first reward and the second reward;
(iv) refining the second agent function in dependence on a performance of the first agent function in meeting the predetermined objective; and
(v) adopting the subsequent environmental state as the current environmental state;
and subsequently:
outputting the current state of the first agent function as the output value function.

2. The machine learning apparatus as claimed in claim 1, wherein the first determining step comprises computing a binary value representing whether or not to use the second reward.

3. The machine learning apparatus as claimed in claim 1, wherein the step of refining the second agent function is performed in dependence on an objective function, which comprises a negative cost element upon determining, on a respective iteration, that the determination of whether to use the second reward has a positive outcome.

4. The machine learning apparatus as claimed in claim 1, wherein the step of refining the second agent function comprises a second determining step comprising: determining whether the subsequent environmental state formed on the respective iteration is in a set of relatively infrequently visited states, and wherein the step of refining the second agent function is performed in dependence on an objective function, which comprises a positive reward element in a condition where, on a respective iteration, that the second determining step has a positive outcome.

5. The machine learning apparatus as claimed in claim 1, wherein the one or more processors are configured to, in a condition where the outcome of the first determining step is positive, refine the first agent function in dependence on the sum of the first reward and the second reward.

6. The machine learning apparatus as claimed in claim 5, wherein the reward function is such that summing the first reward and the second reward preserves pursuit of the objective.

7. The machine learning apparatus as claimed in claim 1, wherein the one or more processors are configured to, on each iteration, compute the second reward only in a condition where the outcome of the first determining step is positive.

8. The machine learning apparatus as claimed in claim 1, wherein the first reward is determined in dependence on the subsequent environmental state.

9. A machine learning apparatus, the machine learning apparatus comprising one or more processors configured to:
form an output value function for achieving a predetermined objective by iteratively learning successive candidates for the output value function in dependence on:
(i) in each iteration, a first reward dependent on an environmental state determined by a current state of the output value function; and
(ii) in at least some iterations, a second reward formed by a second value function; and
learn the second value function over successive iterations.

10. The machine learning apparatus as claimed in claim 9, wherein the subsequent environmental state is formed by a single iteration of the first agent function taking the current environmental state as input.

11. The machine learning apparatus as claimed in claim 9, wherein the performance of the first agent function in meeting the predetermined objective is formed in dependence on the subsequent environmental state and/or the current environmental state.

12. A computer-implemented machine learning method for forming an output value function, the method comprising:
receiving an initial environment state, an initial state of a first agent function and an initial state of a second agent function;
iteratively performing the steps of:
(i) implementing a current state of the first agent function in dependence on a current environmental state to form a subsequent environmental state and a first reward;
(ii) a first determining step comprising determining, using the second agent function, whether to use a second reward;
(iii) in a condition where the first determining step has a negative outcome, refining the first agent function in dependence on the first reward; and otherwise in a condition where the first determining step has a positive outcome, computing the second reward according to a predetermined reward function and refining the first agent function in dependence on the first reward and the second reward;
(iv) refining the second agent function in dependence on a performance of the first agent function in meeting the predetermined objective; and
(v) adopting the subsequent environmental state as the current environmental state;
and subsequently:
outputting the current state of the first agent function as the output value function.

13. A computer implemented machine learning method for forming an output value function for achieving a predetermined objective, the method comprising:
iteratively learning successive candidates for the output value function in dependence on:
(i) in each iteration, a first reward dependent on an environmental state determined by a current state of the output value function; and
(ii) in at least some iterations, a second reward formed by a second value function; and
learning the second value function over successive iterations.

14. A computer-implemented data processing apparatus configured to receive an input and process that input using a function outputted as an output value function by the apparatus of claim 1.

15. The computer-implemented data processing apparatus as claimed in claim 14, wherein the input is an input sensed from an environment in which the data processing apparatus is located.
